(19) United States
(12) Patent Application Publication
(10) Pub. No.: US 2025/0042479 A1
(43) Pub. Date: Feb. 6, 2025

(54) Friction Reduction in Hood Latch Mechanisms for Vehicles

(71) Applicant: Nissan North America, Inc., Franklin, TN (US)

(72) Inventors: Nicholas Trifonoff, Commerce Township, MI (US); Jason Lyman, Whitmore Lake, MI (US); Bobby Fuentes, Clarkston, MI (US); Takeharu Iwata, Atsugi City (JP)

(21) Appl. No.: 18/229,045

(22) Filed: Aug. 1, 2023

(51) Int. Cl. B62D 25/12; E05B 83/24

(52) U.S. Cl. CPC B62D 25/12; E05B 83/24

(57) ABSTRACT

A hood latch mechanism for the hood of a vehicle that includes: a base plate; a rivet extending through the base plate; a hood latch receiving the rivet such that the rivet extends therethrough; a washer receiving the rivet such that the rivet extends therethrough; and a biasing member receiving the rivet such that the rivet extends therethrough. The hood latch is repositionable between a first position, in which the hood latch engages the hood to inhibit opening thereof, and a second position, in which the hood latch is disengaged from the hood to allow opening thereof, wherein the biasing member biases the hood latch towards the first position. The washer is fixedly connected to the hood latch so as to inhibit relative movement therebetween, and is positioned between the base plate and the hood latch to reduce friction therebetween and support movement of the hood latch.

### TECHNICAL FIELD

The present disclosure relates to a hood latch mechanism for the hood of a vehicle and, more specifically, to a hood latch mechanism that includes an anti-friction feature to support the movement thereof between locked (engaged) and unlocked (disengaged) positions.

### BACKGROUND

Hood latch mechanisms for vehicles typically include a hood lock that is operable from inside the passenger compartment in order to partially open the hood, and a hood latch that prevents the hood from fully opening until the hood latch is moved from a locked (engaged) position into an unlocked (disengaged) position.

While certain efforts have been made to improve the operability of hood latch mechanisms, opportunities for further improvement remain, which are addressed by the present disclosure via the incorporation of an anti-friction feature.

### SUMMARY

In one aspect of the present disclosure, a hood latch mechanism for the hood of a vehicle is disclosed that includes: a base plate; a rivet that extends through the base plate; a hood latch that receives the rivet such that the rivet extends therethrough; a washer that receives the rivet such that the rivet extends therethrough; and a biasing member that receives the rivet such that the rivet extends therethrough. The hood latch is repositionable between a first position, in which the hood latch engages the hood to inhibit opening thereof, and a second position, in which the hood latch is disengaged from the hood to allow opening thereof, wherein the biasing member biases the hood latch towards the first position. The washer is fixedly connected to the hood latch so as to inhibit relative movement therebetween, and is positioned between the base plate and the hood latch to reduce friction therebetween and support movement of the hood latch between the first position and the second position.

In certain embodiments, the biasing member may include a first end that is in engagement with the base plate, and a second end that is in engagement with the hood latch.

In certain embodiments, the washer may be mechanically connected to the hood latch.

In certain embodiments, the washer may be non-metallic in construction.

In certain embodiments, the washer may include at least one plastic material.

In certain embodiments, the base plate may include a first aperture having a first transverse cross-sectional dimension.

In certain embodiments, the hood latch may include a second aperture having a second transverse cross-sectional dimension that is larger than the first transverse cross-sectional dimension.

In certain embodiments, the washer may be positioned within the second aperture.

In certain embodiments, the rivet may include: a stem that defines a third transverse cross-sectional dimension, which is less than the first transverse cross-sectional dimension such that the stem is received by the first aperture; a post that extends from the stem and which defines a fourth transverse cross-sectional dimension that is larger than the third transverse cross-sectional dimension but less than the second transverse cross-sectional dimension such that the stem is received by the second aperture; and a trunk that extends from stem and which defines a fifth transverse cross-sectional dimension that is larger than the fourth transverse cross-sectional dimension.

In certain embodiments, the rivet may further include a shoulder that extends radially outward from the trunk so as to render the biasing member captive to the hood latch mechanism.

In another aspect of the present disclosure, a hood latch mechanism for the hood of a vehicle is disclosed that includes: a base plate; a hood latch that is connected to the base plate; and an anti-friction member. The anti-friction member is fixedly connected to the hood latch so as to inhibit relative movement therebetween, and is positioned between the base plate and the hood latch in order to support movement of the hood latch in relation to the base plate.

In certain embodiments, the anti-friction member may define a channel that receives the hood latch such that the hood latch extends into the anti-friction member.

In certain embodiments, the anti-friction member may be configured as a washer.

In certain embodiments, the base plate and the hood latch may be metallic in construction, and the washer may be non-metallic in construction.

In certain embodiments, the hood latch mechanism may further include a rivet that extends through the anti-friction member and the hood latch and into the base plate such that the rivet indirectly connects the hood latch to the base plate.

In certain embodiments, the hood latch mechanism may further include a biasing member that is positioned concentrically in relation to the rivet, wherein the biasing member biases the hood latch towards a normal position in which the hood latch inhibits the hood from opening.

In certain embodiments, the biasing member may be configured as a torsion spring.

In another aspect of the present disclosure, a method of assembling a hood latch mechanism for the hood of a vehicle is disclosed. The method includes: fixedly connecting a washer to a hood latch that is configured for engagement with the hood so as to inhibit relative movement between the washer and the hood latch; inserting a rivet through a biasing member; inserting the rivet through the washer and through the hood latch such that the hood latch is rotatable about the rivet between a locked position, in which the hood latch engages the hood to inhibit opening thereof, and an unlocked position, in which the hood latch is disengaged from the hood to allow opening thereof; and inserting the rivet through a base plate such that the washer is positioned between the base plate and the hood latch in order to reduce friction therebetween and support rotation of the hood latch between the locked position and the unlocked position.

In certain embodiments, fixedly connecting the washer to the hood latch may include mechanically connecting the washer to the hood latch.

In certain embodiments, fixedly connecting the washer to the hood latch may include nesting the hood latch within a channel defined by the washer.

### BRIEF DESCRIPTION OF THE DRAWINGS

According to common practice, the various features of the drawings may not be to scale and may be arbitrarily expanded or reduced for clarity.

FIG. 1 is a top, perspective view of a hood latch mechanism according to the present disclosure.

FIG. 2 is a top, perspective view of the hood latch mechanism shown with parts separated.

FIG. 3 is a cross-sectional view of the hood latch mechanism taken along line 3-3 in FIG. 1.

### DETAILED DESCRIPTION

The present disclosure describes a hood latch mechanism for the hood of a vehicle that includes: a base plate; a hood latch that is repositionable between locked and unlocked positions in order to allow the hood of the vehicle to (fully) open; and a washer that is positioned between the base plate and the hood latch. The washer is fixedly connected to the hood latch so as to inhibit relative movement therebetween, and provides an anti-friction feature that protects the base plate and the hood latch by reducing friction in order to support movement of the hood latch between the locked and unlocked positions.

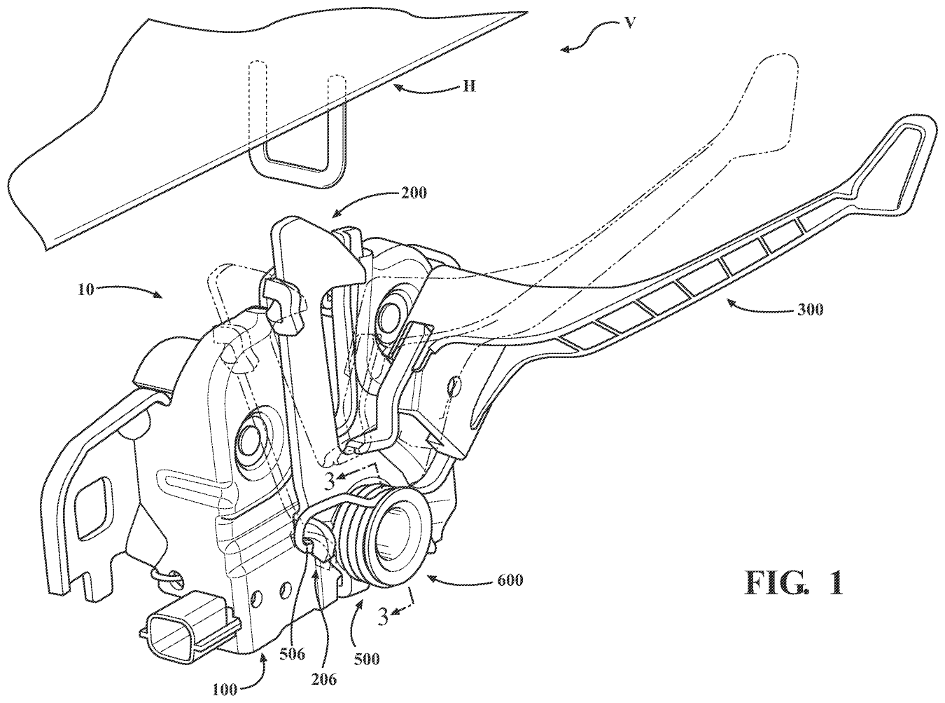

With reference to FIGS. 1-3, the presently disclosed hood latch mechanism will be discussed, which is identified by the reference character 10. The hood latch mechanism 10 is configured to regulate opening of a hood H on a vehicle H and includes: a base plate 100; a hood latch 200; a hood lever 300; a washer 400; a biasing member 500; and a rivet 600. Although generally illustrated as being configured for use in a passenger vehicle, it should be appreciated that the hood latch mechanism 10 may find applicability to a wide variety of vehicles including, for example, trucks, SUVs, vans, etc.

The base plate 100 supports the various components of the hood latch mechanism 10 (e.g., the hood latch 200, the hood lever 300, the washer 400, the biasing member 500, and the rivet 600), and is secured (connected) to a body of the vehicle V, either directly or directly, such that the base plate 100 is fixed in relation thereto. It is envisioned that the base plate 100 may be formed from (e.g., may include) any suitable material or combination of materials. For example, in the illustrated embodiment, the base plate 100 is metallic in construction, and may be formed from at least one (one or more) metallic materials (e.g., steel, aluminum, etc.).

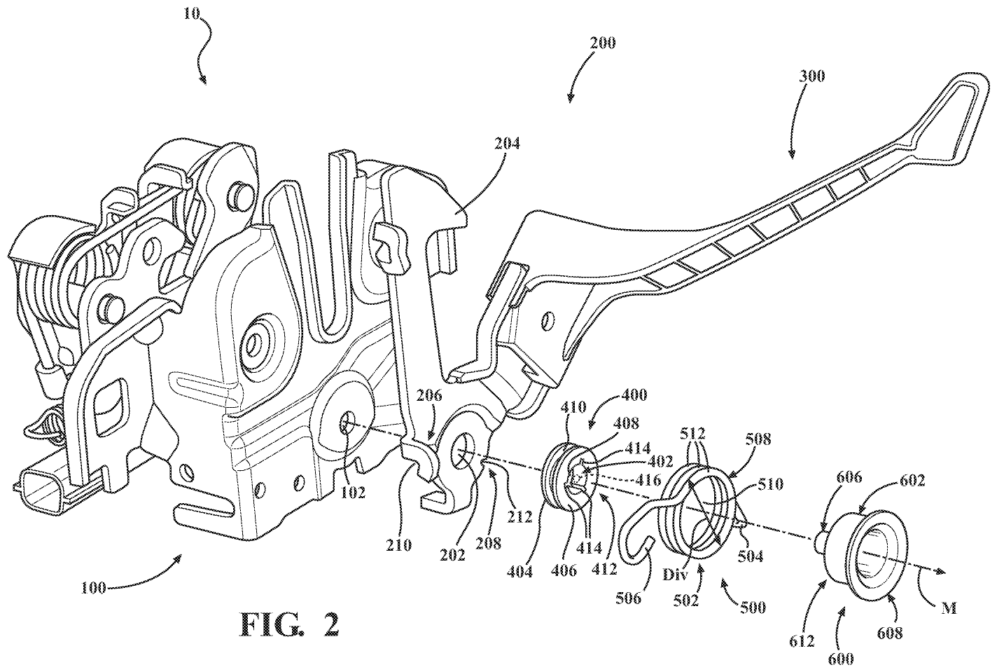

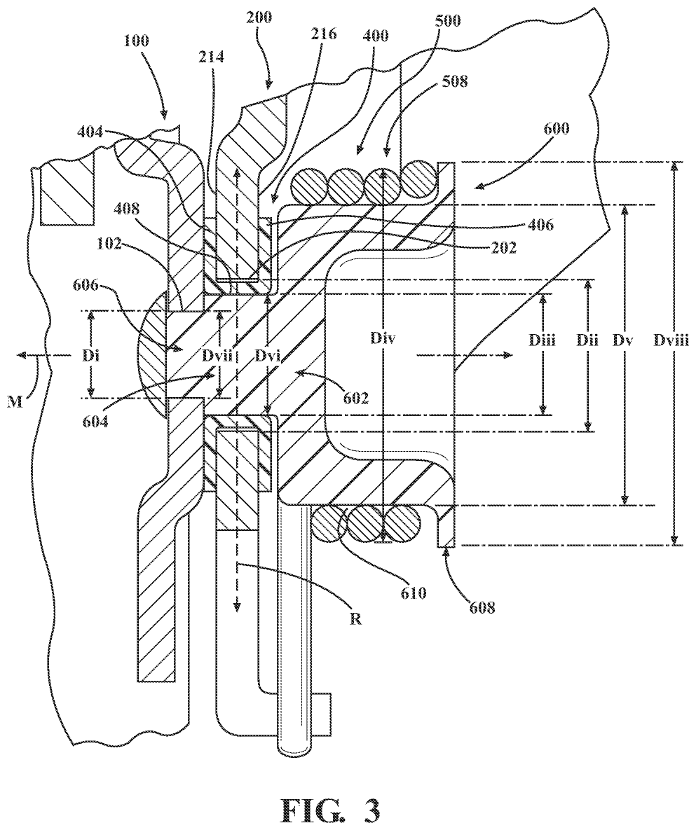

As seen in FIGS. 2 and 3, the base plate 100 defines a (first) aperture 102, which has a (first) transverse cross-sectional dimension (e.g., a diameter) Di (FIG. 3), and is configured to receive the rivet 600 during assembly of the hood latch mechanism 10, as described in further detail below.

The hood latch 200 is movable (e.g., pivotable, rotatable) in relation to the base plate 100 about the rivet 600. More specifically, the hood latch 200 is movable about an axis of movement M (FIGS. 2, 3), which is defined by the rivet 600, between a locked (first, engaged) position and an unlocked (second, disengaged) position. In the locked position, which is shown in solid lines in FIG. 1, the hood latch 200 engages the hood H to inhibit the hood H from (fully) opening, and in the unlocked position, which is shown in phantom in FIG. 1, the hood latch 200 is disengaged from the hood H to thereby allow the hood H to (fully) open.

The hood latch 200 is indirectly connected to the base plate 100 via the rivet 600. More specifically, the hood latch 200 defines a (second) aperture 202 (FIGS. 2, 3) which has a (second) transverse cross-sectional dimension (e.g., a diameter) Dii (FIG. 3) that is larger than the transverse cross-sectional dimension Di, and is generally aligned with the aperture 102 defined by the base plate 100 (e.g., along the axis of movement M). The aperture 202 is configured to receive the rivet 600 in order to facilitate assembly of the hood latch mechanism 10, as described in further detail below.

The hood latch 200 includes: a hook 204; a retainer 206; and a (first) anti-rotation feature 208, and may be formed from (e.g., may include) any suitable material or combination of materials. For example, in the illustrated embodiment, the hood latch 200 is metallic in construction, and may be formed from at least one (one or more) metallic materials (e.g., steel, aluminum, etc.).

The hook 204 is configured for engagement with the hood H in order to prevent the hood H from fully opening until the hood latch 200 is repositioned from the locked position into the unlocked position.

The retainer 206 (FIG. 2) engages (contacts, interfaces with) the biasing member 500. More specifically, the retainer 206 defines an indentation 210 (e.g., a cutout, etc.) that is configured to receive the biasing member 500, as described in further detail below.

The anti-rotation feature 208 is configured as a notch 212 that extends into (e.g., through) the hood latch 200 and engages (contacts, interfaces with) the washer 400. More specifically, the notch 212 is configured to receive a corresponding (second) anti-rotation feature 402 on the washer 400, which inhibits (if not entirely prevents) relative movement (e.g., rotation) between the hood latch 200 and the washer 400 (e.g., during repositioning of the hood latch 200 between the locked and unlocked positions) such that the hood latch 200 and the washer 400 move in unison.

The hood lever 300 is secured (connected to), and extends outwardly (e.g., forwardly) from, the hood latch 200. The hood lever 300 is configured for manual engagement by a user in order to reposition the hood latch 200 from the locked position into the unlocked position.

The washer 400 is fixedly connected (secured) to the hood latch 200. More specifically, the washer 400 is non-movably connected (secured) to the hood latch 200, which may be achieved in any suitable manner. For example, it is envisioned that the washer 400 and the hood latch 200 may be mechanically connected via at least one (one or more) mechanical fasteners (e.g., screws, pins, clips, etc.), adhesively connected, etc. Fixedly connecting the washer 400 to the hood latch 200 further inhibits (if not entirely prevents) relative movement (e.g., rotation) between the hood latch 200 and the washer 400 (e.g., during repositioning of the hood latch 200 between the locked and unlocked positions).

As seen in FIGS. 2 and 3, the washer 400 includes a pair of flanges 404, 406, and defines a (third) aperture 408 (FIGS. 2, 3).

The flanges 404, 406 are spaced from each other (e.g., along the axis of movement M) so as to define a channel 410, which is generally annular in configuration and is configured to receive the hood latch 200 such that the hood latch 200 extends into (e.g., nests within) the washer 400. More specifically, as seen in FIG. 3, upon assembly of the hood latch mechanism 10, the washer 400 is located (positioned) with the aperture 202 such that the flanges 404, 406 extend onto opposing faces 214, 216 of the hood latch 200. The washer 400 is thus located (positioned) between and separates the base plate 100 and the hood latch 200 such that the hood latch 200 is indirectly connected to the base plate 100 by the rivet 600.

Positioning the washer 400 between the base plate 100 and the hood latch 200 not only protects any surface coatings on the base plate 100 and the hood latch 200, but reduces friction therebetween to support movement (e.g., pivoting, rotation) of the hood latch 200 between the locked position and the unlocked position. The washer 400 thus acts as (and provides) a (first) anti-friction feature (member) 412 in the hood latch mechanism 10.

It is envisioned that the washer 400 may be formed from (e.g., may include) any material or combination of materials suitable for the intended purpose of reducing friction between the base plate 100 and the hood latch 200. For example, in the illustrated embodiment, the washer 400 is non-metallic in construction, and may be formed from at least one (one or more) non-metallic materials (e.g., polymeric material(s), plastic material(s), composite material(s), etc.). In order to enhance the protection of the base plate 100 and the hood latch 200 provided by the washer 400, it is envisioned that the material(s) utilized in construction of the washer 400 may include a lower durometer than the material(s) used in construction of the base plate 100 and the hood latch 200.

In order to allow for thermal loading during repositioning of the hood latch 200 between the locked position and the unlocked position, in certain embodiments, such as that illustrated in FIGS. 1-3, it is envisioned that the washer 400 may include at least one (one or more) expansion joints 414 (FIG. 2). Although illustrated as including three expansion joints 414, it should be appreciated that the particular number of expansion joints 414 may be increased or decreased in alternate embodiments without departing from the scope of the present disclosure.

The aperture 408 has a (third) transverse cross-sectional dimension (e.g., a diameter) Diii (FIG. 3) that is larger than the transverse cross-sectional dimension Di, but smaller than the transverse cross-sectional dimension Dii. The aperture 408 is configured to receive the rivet 600, which facilitates assembly of the hood latch mechanism 10, as described in further detail below, and is generally aligned with the apertures 102, 202 respectively defined by the base plate 100 and the hood latch 200 (e.g., along the axis of movement M). More specifically, as a result of the positioning of the washer 400 about the hood latch 200 (e.g., via reception of the hood latch 200 within the channel 410), the apertures 202, 408 are generally aligned along a reference axis R (FIG. 3) that extends in generally orthogonal relation to the axis of movement M.

As indicated above, relative movement (e.g., rotation) between the hood latch 200 and the washer 400 is also inhibited (if not entirely prevented) via engagement (contact) between the anti-rotation feature 208 on the hood latch 200 and the anti-rotation feature 402 on the washer 400, which is configured as a detent 416 (FIG. 2) (or other such projection). The detent 416 extends outwardly from the washer 400 and is located (positioned) within (is inserted into) the notch 212 during assembly of the hood latch mechanism 10.

The biasing member 500 is extends (is located, positioned) about the rivet 600 and, in the illustrated embodiment, is configured as a (torsion) spring 502 that acts upon the hood latch 200 to bias the hood latch 200 towards the locked position and thereby automatically return the hood latch 200 to the locked position upon release of the hood lever 300. The biasing member 500 includes: a first end 504 (FIG. 2); a second end 506; and a body portion 508, which is located (positioned) between the first end 504 and the second end 506 and has a (fourth) transverse cross-sectional dimension (e.g., a diameter) Div.

The first end 504 of the biasing member 500 engages (contacts, interfaces with) the base plate 100. More specifically, the first end 504 of the biasing member 500 extends about (wraps, loops around) the base plate 100, which inhibits (if not entirely prevents) movement of the first end 504 in relation thereto (e.g., during repositioning of the hood latch 200 between the locked and unlocked positions).

The second end 506 of the biasing member 500 engages (contacts, interfaces with) the hood latch 200. More specifically, the second end 506 of the biasing member 500 extends about (wraps, loops around) the retainer 206 and is located (positioned) within (is received by) the indentation 210, which inhibits (if not entirely prevents) movement of the second end 506 in relation to the hood latch 200 (e.g., during repositioning of the hood latch 200 between the locked and unlocked positions).

The respective interfaces between the ends 504, 506 of the biasing member 500 and the hood latch 200 allow for the creation of a biasing force in the biasing member 500 upon repositioning of the hood latch 200 from the locked position to the unlocked position. More specifically, the biasing force created in the biasing member 500 is stored within the body portion 508 such that, upon release of the hood lever 300 by the user, the biasing force (automatically) restores the locked position of the hood latch 200, as indicated above.

The body portion 508 includes a coiled configuration that defines a passage 510 (FIG. 2). Although shown as including three turns 512i, 512ii, 512iii, it is envisioned that the number of turns 512 may be increased or decreased in alternate embodiments without departing from the scope of the present disclosure.

The passage 510 is generally aligned with the apertures 102, 202, 408 respectively defined by the base plate 100, the hood latch 200, and the washer 400 (e.g., along the axis of movement M), and is configured to receive the rivet 600, which facilitates assembly of the hood latch mechanism 10, as described in further detail below. More specifically, as seen in FIG. 3, upon assembly of the hood latch mechanism 10, washer 400, the biasing member 500, and the rivet 600 are positioned concentrically in relation to each other.

The rivet 600 includes: a trunk 602; a post 604; a stem 606; and a shoulder 608, each of which includes a generally annular transverse cross-sectional configuration. With reference to FIG. 3 in particular, the trunk 602 has a (fifth) transverse cross-sectional dimension (e.g., a diameter) Dv, the post 604 extends axially from the trunk 602 (e.g., towards the base plate 100) and has a (sixth) transverse cross-sectional dimension (e.g., a diameter) Dvi, the stem 606 extends axially from the post 604 (e.g., towards the base plate 100) and has a (seventh) transverse cross-sectional dimension (e.g., a diameter) Dvii, and the shoulder 608 has an (eighth) transverse cross-sectional dimension (e.g., a diameter) Dviii.

The transverse cross-sectional dimension Dv defined by the trunk 602 is larger than the transverse cross-sectional dimensions Diii, Dvi respectively defined by the aperture 408 (in the washer 400) and the post 604, but smaller than the transverse cross-sectional dimension Div defined by the body portion 508 of the biasing member 500, which prevents over-advancement of the rivet 600 (e.g., towards the base plate 100) during assembly of the hood latch mechanism 10.

The transverse cross-sectional dimension Dvi defined by the post 604 is less than the transverse cross-sectional dimensions Dii, Diii, Dv respectively defined by the aperture 202 (in the hood latch 200), the aperture 408 (in the washer 400), and the trunk 602, which allows for insertion of the post 604 into the aperture 202 during assembly of the hood latch mechanism 10, as described in further detail below.

The transverse cross-sectional dimension Dvii defined by the stem 606 is less than the transverse cross-sectional dimensions Di, Dvi respectively defined by the aperture 102 (in the base plate 100) and the post 604, which allows for insertion of the stem 606 into the aperture 102 during assembly of the hood latch mechanism 10, as described in further detail below.

The transverse cross-sectional dimension Dviii defined by the shoulder 608 is greater than the transverse cross-sectional dimensions Div, Dv respectively defined by the body portion 508 of the biasing member 500 and the trunk 602, whereby the shoulder 608 extends radially (laterally) outward from the trunk 602 (e.g., in generally orthogonal relation to the trunk 602 and the axis of movement M). The shoulder 608 and the trunk 602 thus collectively define a receiving space 610 (FIG. 3) that is configured to receive the biasing member 500 (e.g., the body portion 508), as described in further detail below.

The rivet 600 facilitates connection of the base plate 100, the hood latch 200, the washer 400, and the biasing member 500 during assembly of the hood latch mechanism 10, and extends through the biasing member 500 (e.g., via the passage 510 (FIG. 2) defined by the body portion 508), and through the washer 400, the hood latch 200, and the base plate 100 (e.g., via the respective apertures 408, 202, 102), as seen in FIGS. 2 and 3. The base plate 100, the hood latch 200, the washer 400, and the biasing member 500 thus each receive the rivet 600 such that the rivet 600 extends therethrough, whereby the rivet 600 defines the axis of movement M, about which the hood latch 200 moves (e.g. pivots, rotates) during repositioning between the locked position and the unlocked position.

As seen in FIG. 3, upon assembly of the hood latch mechanism 10, the biasing member 500 (e.g., the body portion 508) is located (positioned) between the hood latch 200 and the shoulder 608 about the trunk 602 (e.g., within the receiving space 610), which renders the biasing member 500 captive to the hood latch mechanism 10. Additionally, the post 604 extends through the washer 400 and the hood latch 200 via the respective apertures 408, 202, and the stem 606 extends through the base plate 100 via the aperture 102.

It is envisioned that the rivet 600 may be formed from (e.g., may include) any material or combination of materials suitable for the intended purpose of connecting the various components of the hood latch mechanism 10 in the manner described herein. For example, in the illustrated embodiment, the rivet 600 is non-metallic in construction, and may be formed from at least one (one or more) non-metallic materials (e.g., polymeric material(s), plastic material(s), composite material(s), etc.), which not only protects any surface coatings on the base plate 100 and the washer 400, but further reduces friction in order to support movement of the hood latch 200 during repositioning between the locked position and the unlocked position. The rivet 600 thus acts as (and provides) a (second) anti-friction feature (member) 612 in the hood latch mechanism 10.

The rivet 600 is mechanically connected to the base plate 100, which secures the rivet 600, the biasing member 500, the washer 400, and the hood latch 200 in relation thereto. More specifically, in the illustrated embodiment, the stem 606 is peened onto the base plate 100, as seen in FIG. 3. It is envisioned that the rivet 600 and the base plate 100 may be connected or secured in relation to each other in any suitable manner, however. For example, an embodiment in which at least one (one or more) mechanical fasteners (e.g., screws, pins, clips, etc.) may be utilized to connect or secure the rivet 600 and the base plate 100 in relation to each other would not be beyond the scope of the present disclosure.

With continued reference to FIGS. 1-3, a method of assembling the hood latch mechanism 10 will be discussed.

Initially, the washer 400 is connected to the hood latch 200 such that hood latch 200 nests within the channel 410 (FIG. 2), whereby the flanges 404, 406 extend onto the opposing faces 214, 216 (FIGS. 2, 3) of the hood latch 200. Thereafter, the hood latch 200 (and the washer 400) are oriented in relation to the base plate 100 such that the apertures 102, 202, 408 respectively defined by the base plate 100, the hood latch 200, and the washer 400 are generally aligned. The rivet 600 is then inserted through the biasing member 500, through the washer 400 and the hood latch 200, and through the base plate 100 such that the washer 400 is located (positioned) between the base plate 100 and the hood latch 200 in order to reduce friction therebetween and support rotation of the hood latch 200 between the locked position and the unlocked position. More specifically, during assembly of the hood latch mechanism 10, the rivet 600 is located (positioned) such that the trunk 602 extends into the biasing member 500 via the passage 510 defined by the body portion 508, the post 604 extends into the washer 400 and the hood latch 200 via the respective apertures 408, 202, and the stem 606 extends into the base plate 100 via the aperture 102.

The rivet 600 is then mechanically connected to the base plate 100 (e.g., by peening the stem 606 onto the base plate 100, as seen in FIG. 3), which secures (connects) the hood latch 200 to the base plate 100, and retains the biasing member 500 between the rivet 600 (e.g., the shoulder 608) and the hood latch 200. Mechanical connection of the rivet 600 to the base plate 100 thus secures the hood latch 200, the washer 400, the biasing member 500, and the rivet 600 in relation to the base plate 100, and facilitates repositioning (e.g., pivoting, rotation) of the hood latch 200 about the rivet 600 and in relation to the base plate 100 between the locked and unlocked positions.

Either prior or subsequent to connection of the rivet 600 to the base plate 100, the ends 504, 506 (FIG. 2) of the biasing member 500 are secured in relation to the base plate 100 and the hood latch 200. More specifically, the first end 504 of the biasing member 500 is positioned about the base plate 100, and the second end 506 of the biasing member 500 is positioned about the retainer 206 and within the indentation 210 (FIG. 2).

Persons skilled in the art will understand that the various embodiments of the disclosure described herein and shown in the accompanying figures constitute non-limiting examples, and that additional components and features may be added to any of the embodiments discussed herein above without departing from the scope of the present disclosure. Additionally, persons skilled in the art will understand that the elements and features shown or described in connection with one embodiment may be combined with those of another embodiment without departing from the scope of the present disclosure and will appreciate further features and advantages of the presently disclosed subject matter based on the description provided. Variations, combinations, and/or modifications to any of the embodiments and/or features of the embodiments described herein that are within the abilities of a person having ordinary skill in the art are also within the scope of the disclosure, as are alternative embodiments that may result from combining, integrating, and/or omitting features from any of the disclosed embodiments.

Use of broader terms such as “comprises.” “includes,” and “having” should be understood to provide support for narrower terms such as “consisting of,” “consisting essentially of,” and “comprised substantially of.” Accordingly, the scope of protection is not limited by the description set out above but is defined by the claims that follow and includes all equivalents of the subject matter of the claims.

In the preceding description, reference may be made to the spatial relationship between the various structures illustrated in the accompanying drawings, and to the spatial orientation of the structures. However, as will be recognized by those skilled in the art after a complete reading of this disclosure, the structures described herein may be positioned and oriented in any manner suitable for their intended purpose. Thus, the use of terms such as “above,” “below,” “upper.” “lower,” “inner,” “outer,” “left,” “right.” “upward,” “downward,” “inward,” “outward,” etc., should be understood to describe a relative relationship between the structures and/or a spatial orientation of the structures. Those skilled in the art will also recognize that the use of such terms may be provided in the context of the illustrations provided by the corresponding figure(s).

Additionally, terms such as “approximately,” “generally.” “substantially,” and the like should be understood to allow for variations in any numerical range or concept with which they are associated and encompass variations on the order of 25% (e.g., to allow for manufacturing tolerances and/or deviations in design). For example, the term “generally parallel” should be understood as referring to configurations in with the pertinent components are oriented so as to define an angle therebetween that is equal to 182°±25% (e.g., an angle that lies within the range of (approximately) 135° to (approximately)) 225° and the term “generally orthogonal” should be understood as referring to configurations in with the pertinent components are oriented so as to define an angle therebetween that is equal to 90°±25% (e.g., an angle that lies within the range of (approximately) 67.5° to (approximately)) 112.5°. The term “generally parallel” should thus be understood as referring to encompass configurations in which the pertinent components are arranged in parallel relation, and the term “generally orthogonal” should thus be understood as referring to encompass configurations in which the pertinent components are arranged in orthogonal relation.

Although terms such as “first,” “second,” “third,” etc., may be used herein to describe various operations, elements, components, regions, and/or sections, these operations, elements, components, regions, and/or sections should not be limited by the use of these terms in that these terms are used to distinguish one operation, element, component, region, or section from another. Thus, unless expressly stated otherwise, a first operation, element, component, region, or section could be termed a second operation, element, component, region, or section without departing from the scope of the present disclosure.

Each and every claim is incorporated as further disclosure into the specification and represents embodiments of the present disclosure. Also, the phrases “at least one of A, B, and C” and “A and/or B and/or C” should each be interpreted to include only A, only B, only C, or any combination of A, B, and C.

What is claimed is:

1. A hood latch mechanism for a hood of a vehicle, the hood latch mechanism comprising:
a base plate;
a rivet extending through the base plate;
a hood latch receiving the rivet such that the rivet extends therethrough, the hood latch being repositionable between a first position, in which the hood latch engages the hood to inhibit opening thereof, and a second position, in which the hood latch is disengaged from the hood to allow opening thereof;
a washer receiving the rivet such that the rivet extends therethrough, wherein the washer is fixedly connected to the hood latch so as to inhibit relative movement therebetween, wherein the washer is positioned between the base plate and the hood latch to reduce friction therebetween and support movement of the hood latch between the first position and the second position; and
a biasing member receiving the rivet such that the rivet extends therethrough, the biasing member biasing the hood latch towards the first position.

2. The hood latch mechanism of claim 1, wherein the biasing member includes a first end in engagement with the base plate, and a second end in engagement with the hood latch.

3. The hood latch mechanism of claim 1, wherein the washer is mechanically connected to the hood latch.

4. The hood latch mechanism of claim 1, wherein the washer is non-metallic in construction.

5. The hood latch mechanism of claim 4, wherein the washer includes at least one plastic material.

6. The hood latch mechanism of claim 1, wherein the base plate includes a first aperture having a first transverse cross-sectional dimension.

7. The hood latch mechanism of claim 6, wherein the hood latch includes a second aperture having a second transverse cross-sectional dimension larger than the first transverse cross-sectional dimension.

8. The hood latch mechanism of claim 7, wherein the washer is positioned within the second aperture.

9. The hood latch mechanism of claim 7, wherein the rivet includes:
a stem defining a third transverse cross-sectional dimension less than the first transverse cross-sectional dimension such that the stem is received by the first aperture;
a post extending from the stem and defining a fourth transverse cross-sectional dimension larger than the third transverse cross-sectional dimension but less than the second transverse cross-sectional dimension such that the stem is received by the second aperture; and
a trunk extending from stem and defining fifth transverse cross-sectional dimension larger than the fourth transverse cross-sectional dimension.

10. The hood latch mechanism of claim 9, wherein the rivet further includes:
a shoulder extending radially outward from the trunk so as to render the biasing member captive to the hood latch mechanism.

11. A hood latch mechanism for a hood of a vehicle, the hood latch mechanism comprising:
a base plate;
a hood latch connected to the base plate; and
an anti-friction member fixedly connected to the hood latch so as to inhibit relative movement therebetween, wherein the anti-friction member is positioned between the base plate and the hood latch in order to support movement of the hood latch in relation to the base plate.

12. The hood latch mechanism of claim 11, wherein the anti-friction member defines a channel receiving the hood latch such that the hood latch extends into the anti-friction member.

13. The hood latch mechanism of claim 11, wherein the anti-friction member is configured as a washer.

14. The hood latch mechanism of claim 13, wherein the base plate and the hood latch are metallic in construction, and the washer is non-metallic in construction.

15. The hood latch mechanism of claim 11, further comprising:
a rivet extending through the anti-friction member and the hood latch and into the base plate such that the rivet indirectly connects the hood latch to the base plate.

16. The hood latch mechanism of claim 15, further comprising:
a biasing member positioned concentrically in relation to the rivet, wherein the biasing member biases the hood latch towards a normal position in which the hood latch inhibits the hood from opening.

17. The hood latch mechanism of claim 16, wherein the biasing member is configured as a torsion spring.

18. A method of assembling a hood latch mechanism for a hood of a vehicle, the method comprising:
fixedly connecting a washer to a hood latch configured for engagement with the hood so as to inhibit relative movement between the washer and the hood latch;
inserting a rivet through a biasing member;
inserting the rivet through the washer and through the hood latch such that the hood latch is rotatable about the rivet between a locked position, in which the hood latch engages the hood to inhibit opening thereof, and an unlocked position, in which the hood latch is disengaged from the hood to allow opening thereof; and
inserting the rivet through a base plate such that the washer is positioned between the base plate and the hood latch in order to reduce friction therebetween and support rotation of the hood latch between the locked position and the unlocked position.

19. The method of claim 18, wherein fixedly connecting the washer to the hood latch includes mechanically connecting the washer to the hood latch.

20. The method of claim 18, wherein fixedly connecting the washer to the hood latch includes nesting the hood latch within a channel defined by the washer.
